(19) United States
(12) Patent Application Publication
(10) Pub. No.: US 2004/0186838 A1
(43) Pub. Date: Sep. 23, 2004

(54) System for acquiring and managing digital records

(75) Inventor: Jeffrey W. Johnson, Potomac Falls, VA (US)

Correspondence Address: WOMBLE CARLYLE SANDRIDGE & RICE, PLLC, P.O. BOX 7037, ATLANTA, GA, 30357-0037, US

(73) Assignee: Arcemus, LLC, Dulles, VA

(21) Appl. No.: 10/804,127

(22) Filed: Mar. 19, 2004

Related U.S. Application Data
(60) Provisional application No. 60/455,864, filed on Mar. 20, 2003.

(51) Int. Cl. G06F 17/30

(52) U.S. Cl. 707/10

(57) ABSTRACT

A system for acquiring and managing digital records for an organization receives a request for an action on a digital record that includes predefined critical elements. The system then presents one or more profiles for at least one of the critical elements. The critical elements and the profiles incorporate the digital record management policy and procedures of the organization. The system then receives a selection of one of the one or more profiles and executes the action based on the selection.

### BACKGROUND INFORMATION

With the burgeoning use of computers to create and store the majority of corporate data, companies are increasingly concerned about the acquisition, management and enforcement of electronic data. Of primary concern is a company's digital “vital records”. Digital vital records can be considered the approximately 5% of a company's records that must be maintained in such a way that if a catastrophic event were to occur, the digital vital records could be retrieved and could reconstitute the company and maintain its operations and business continuity in a very short period of time. Examples of digital vital records include domain name records, tax records, finance records, legal records, registered agent records, governance records, customer and vendor agreements, etc.

Of particular importance is a company's digital Internet domain name records. Domain name records comprise all required information for each domain name registered or belonging to the company and its subsidiaries and/or affiliates. There are currently more than 7 generic top level domains (e.g., .com, .net, .gov) and more than 243 country code top and/or sub-level domains (e.g., .co, .uk, .de, .tv). A company may desire to register all of its trademarks and other similar intellectual property, such as the company name, product names, etc., in substantially more than 250 top-level and more than 900 sub-level domains resulting in the acquisition of a unique domain name record for each such registration. This can quickly lead to hundreds, if not thousands of global domain name records that form an electronic business link between a company and its respective clients and business partners for even a medium size company.

It is critical for a company to properly acquire and manage each of its domain name records. For example, each domain name record includes a registrant, administrative, technical, and billing contact, including name, telephone number, e-mail, and other relevant contact and/or technical information needed for the proper function and enforcement of these digital records. At many companies, the person registering the domain name record may have used their personal contact information during acquisition. When the renewal for the relevant domain name record comes due, the renewal notice is then sent to the person's individual contact information. However, if for whatever reason that person was no longer with the company, the renewal notice may never be received resulting in the expiration and associated abandonment of this digital vital record. The immediate result is that all electronic e-mail communication and e-commerce process will cease immediately. Potentially even more serious, after expiration the domain name record is available to be registered by anyone else, including the company's competitors and malicious hackers (i.e., cybersquatters), who may purchase rights to the domain name record and reroute electronic queries directed to the company's web site to undesirable web sites.

Most companies have absolutely no policies or documented procedures regarding the management of digital vital records. In rare cases, a company will write a policy statement resulting in the filing and/or communication of this policy through traditional means (e.g., posted on a bulletin board, or filed in a paper repository for reference) in an attempt to update its existing policies and procedures to insure that digital records are managed properly. However, there are no effective enforcement systems to monitor the maintenance and use of these record policies and procedures so they are typically ignored. As a result, the acquisition and management of digital vital records is frequently done on an ad-hoc basis and is disorganized, with potentially devastating negative consequences (e.g., business disruptions, non-regulatory compliance, etc.).

Based on the foregoing, there is a need for a system and method that provides for the acquisition, management, and enforcement of digital vital records in accordance with a company's policy and procedures.

### SUMMARY OF THE INVENTION

One embodiment of the present invention is a system for acquiring and managing digital records for an organization. The system receives a request for an action on a digital record that includes predefined critical elements. The system then presents one or more profiles for at least one of the critical elements. The critical elements and the profiles incorporate the digital record management policy and procedures of the organization. The system then receives a selection of one of the one or more profiles and executes the action based on the selection.

### BRIEF DESCRIPTION OF THE DRAWINGS

FIG. 1 is a block diagram illustrating a system for acquiring and managing domain name records in accordance to one embodiment of the present invention.

FIG. 2 is a flowchart illustrating some of the functionality of embodiments of the present invention.

FIG. 3 illustrates a graphical user interface that is used for setting up and creating TLD profiles.

FIG. 4 illustrates a graphical user interface that is used for submitting work requests.

FIG. 5 illustrates a graphical user interface that is used for confirming work requests.

### DETAILED DESCRIPTION

One embodiment of the present invention is a system for managing digital vital records by creating a series of profiles that are used to capture critical elements of record information which can be centrally managed. These profiles define and capture an organization's procedures and policies regarding the acquisition and management of its digital vital records.

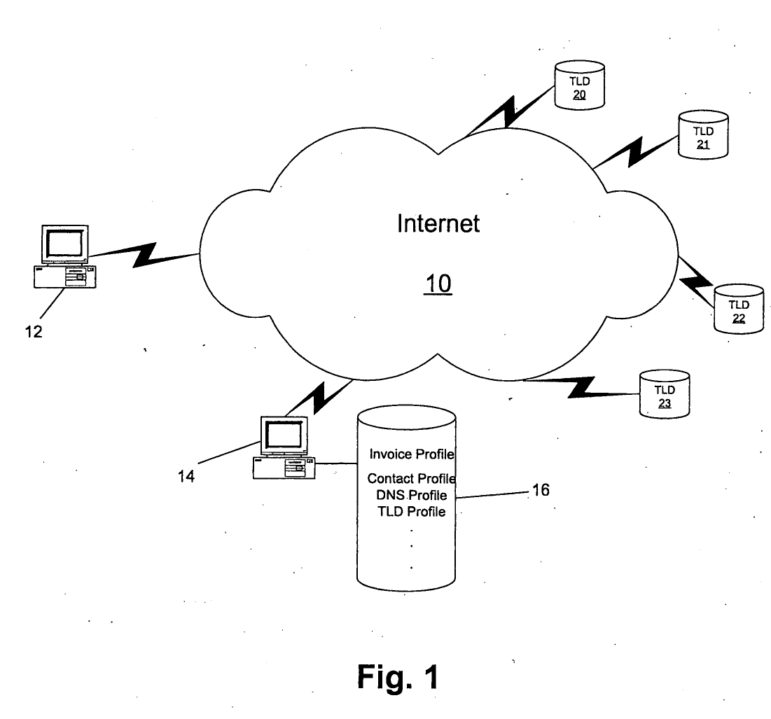

FIG. 1 is a block diagram illustrating a system for acquiring and managing domain name records in accordance to one embodiment of the present invention. Although the embodiment shown in FIG. 1 is directed to domain name records, other embodiments could apply to any type of digital vital records.

The system comprises a computer 14 having a database 16 that stores a series of profiles. In one embodiment, one or more profiles are created for each critical element of a domain name record. Database 16 includes invoice profiles, contact profiles, domain name server (“DNS”) profiles and Top-Level Domain (“TLD”) profiles. Other profiles, depending on the type of digital record to be managed, would be added and stored in database 16.

Computer 14 can be any type of general purpose computer having a processor and memory. Computer 14 is connected to the Internet 10, or any other network that allows for electronic communication. Also coupled to Internet 10 is a computer 12 where a user of the secure system will interface with the system to acquire, manage, and enforce domain name records. TLDs 20-23 are also coupled to Internet 10. TLDs 20-23 are the databases (and associated computer systems) for each of the TLDs that are configured to allow a user to acquire a domain name for the domain corresponding with the TLD. Therefore, for example, the “.com” TLD database would be accessed when a user desires to acquire the domain name records “xyz.com”. Although only four TLDs are shown in FIG. 1, it is understood that all TLDs are maintained and present as part of the global Internet navigation structure 10.

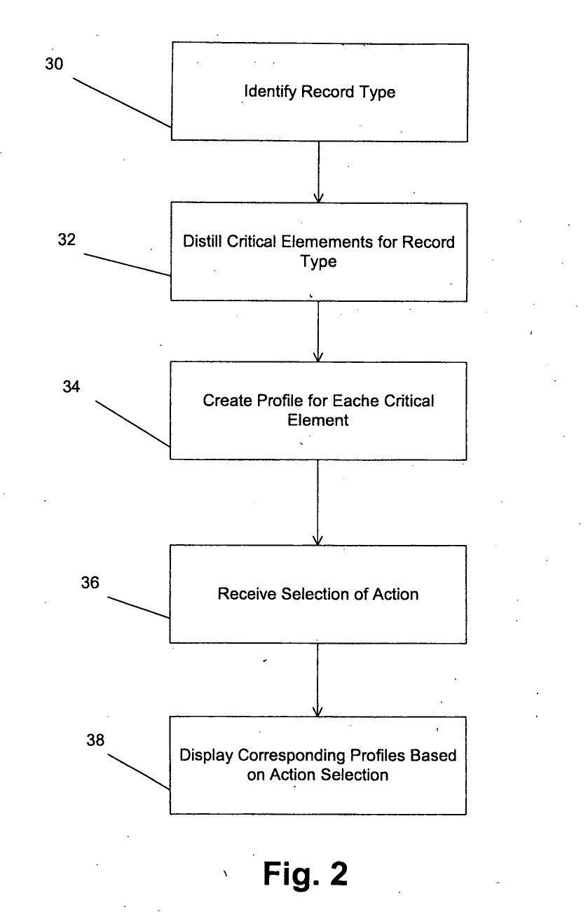

FIG. 2 is a flowchart illustrating some of the functionality of embodiments of the present invention. The functionality in FIG. 2 can be implemented in software, hardware, or any combination of software or hardware.

At box 30, the record type that is to be managed by the system is identified. In one embodiment, the record type is a domain name record. In other embodiments, the record type can be any type of digital vital record, including trademark registration records, license records, registered agent records, tax records, etc.

At box 32, the critical elements for the record type are distilled (i.e., a determination is made as to the critical data elements required for that digital vital record type). For example, for a domain name record, the critical data elements may be considered the registrant information (e.g., the name and address of the company name, and the name, telephone number and e-mail of a contact person at the company); the contact information (i.e., the name, address and e-mail of an administrative contact, a billing contact, and a technical contact); and technical DNS information (i.e., the domain name server or servers that correspond to the domain name and through which traffic for that domain name will be routed to). The selection of the critical elements is a reflection of the company's policy and procedures regarding its digital vital records.

At box 34, profiles are created for each identified critical element. In one embodiment, a profile is predetermined information that can be supplied for each element and that adheres to a company's policies and procedures. For example, the contact information profile can list the name, address, e-mail and other contact information of the designated role accounts (e.g., legal@xyz.com, administrator@xyz.com, Hostmaster@xyz.com) that have been designated by the company to be considered domain name record contacts for the company. This prevents different contact information from being entered for each domain name record, and further prevents the problem described above where the contact person listed in the domain name record is no longer with the company, so that any information from the TLD does not reach a responsible person at the company. One or more profiles may be created for each critical record element.

At box 36, computer 14 receives a selection of an action from a user. Examples of actions include adding, changing, and deleting a record. When the action is selected, then at box 38 the profiles that are specific to that action are displayed to the user and the user can then choose the desired profile for each category.

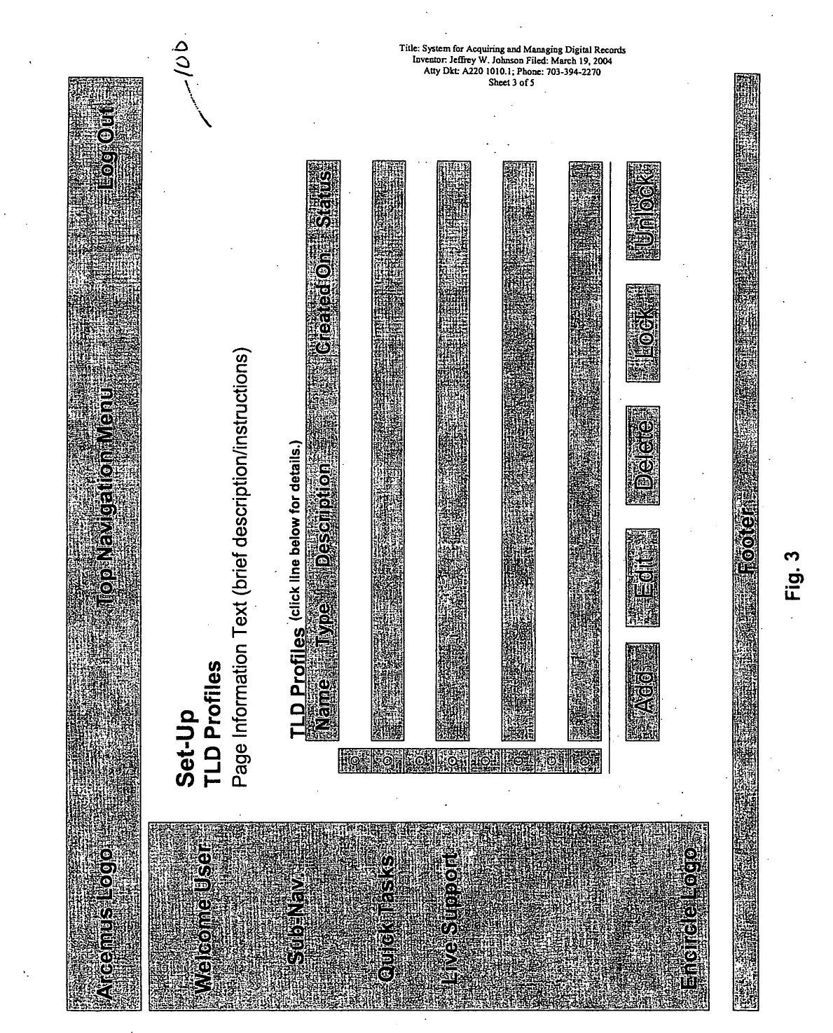

FIG. 3 illustrates a graphical user interface 100 that is used for setting up and creating TLD profiles. A similar interface can be used for setting up and creating other types of profiles. In one embodiment, only an administrative user has authority to create new and modify existing profiles. Other users, such as standard users or read only users, do not have access to create or modify a company's profiles. Graphical user interface 100 is generated on computer 14 and is accessed by a user at computer 12. A TLD profile may limit the TLDs available for a user to register domain names. For example, a company may determine that most domain names will be registered in 60 countries, rather than with all 243+ country top-level and sub-level domains, because those 60 countries are the primary countries where the company sells its products and protects its intellectual property. A “standard” profile can be created using interface 100 to limit the TLDs to those 60 countries. A similar interface to interface 100 will be used to create all of the profiles for a company's digital records.

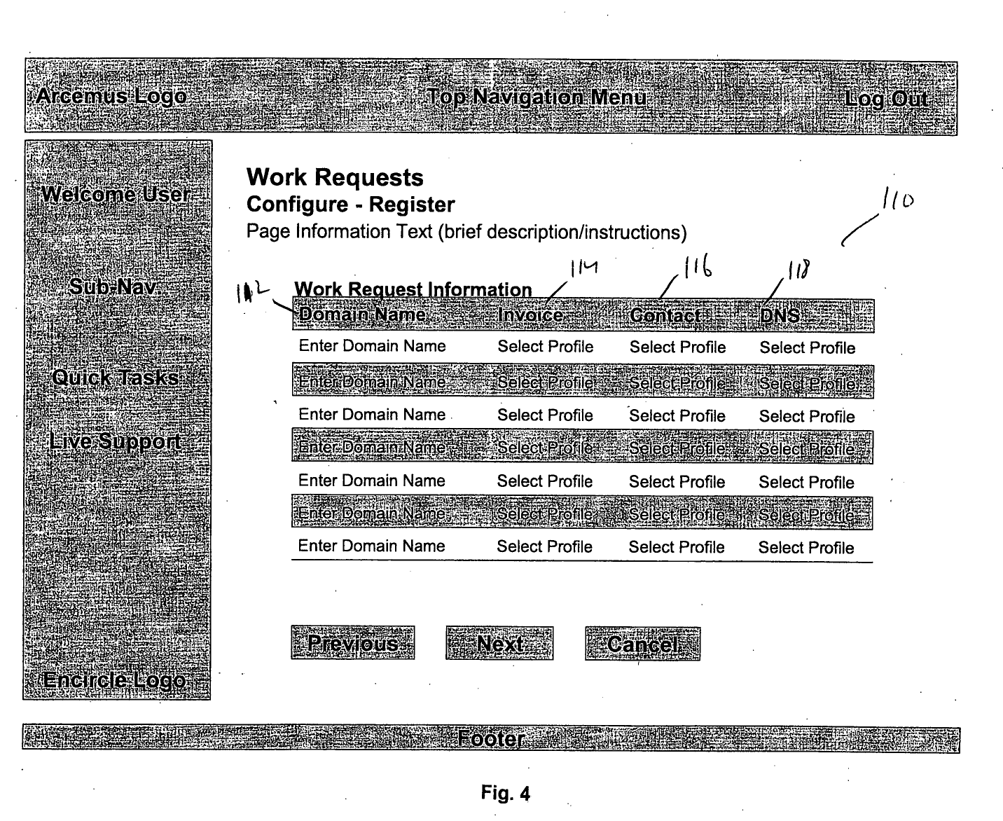

FIG. 4 illustrates a graphical user interface 110 that is used for submitting work requests. A work request is a request for services such as registering a domain name record, modifying a domain name record, deleting a domain name record, etc. Interface 110 is directed to registering a new domain name record. A menu provides the relevant information for the work request selected, including all relevant profiles. The number of profiles displayed varies depending on the work request and is context sensitive. For example, when registering a domain name, 3 profiles may be displayed, and when modifying a domain name only 2 profiles may be displayed.

For registering a new domain name on interface 110, the user must input the new domain name in column 112. The user then must select an invoice profile from column 114, a contact profile form column 116, and a DNS profile from column 118. For each column category, the user will have one or more profiles to choose from (via, for example, pull-down menus), but the user will not be allowed to modify or add to the information in each profile. Therefore, the user is confined to using the predetermined profiles, which reflect the company's policies and procedures relevant to the work request the user is performing (i.e., registering a new domain name). Once all of the required profiles are selected, the system in accordance with one embodiment of the present invention performs all of the registration processes by securely interfacing with the appropriate TLD Registry database via the Internet resulting in the successful registration of the requested domain name record at each specified TLD.

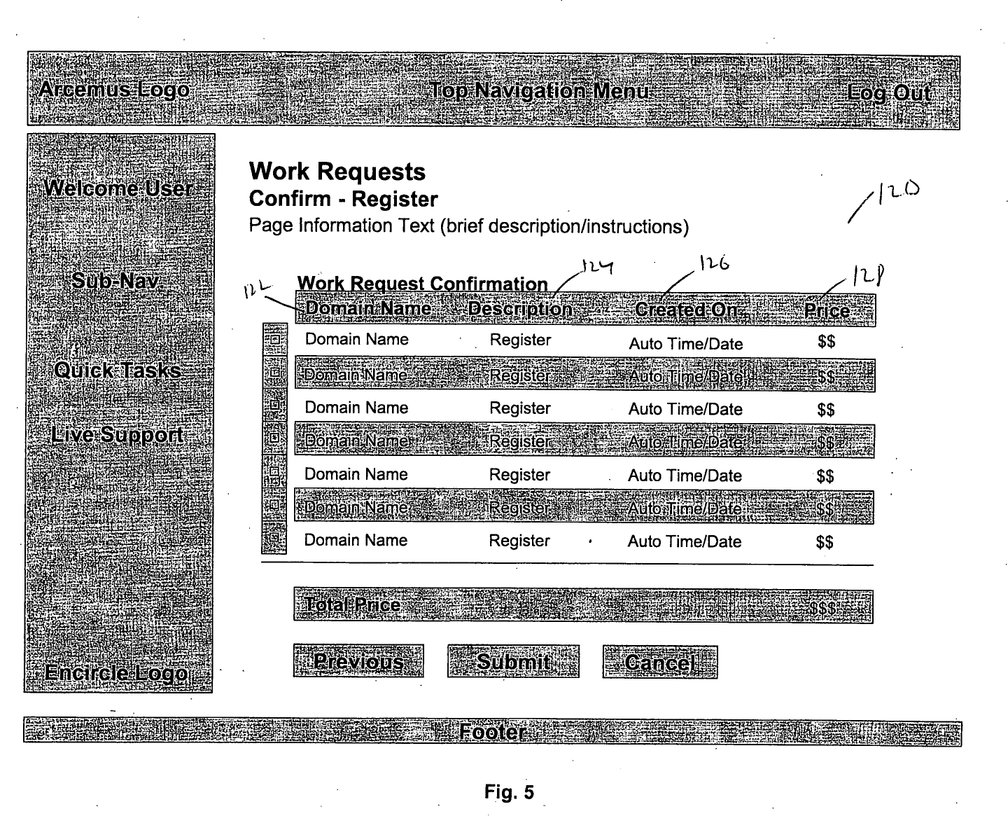

FIG. 5 illustrates a graphical user interface 120 that is used for confirming work requests. Interface 120 includes a menu that provides a domain name column 122, a description column 124 that provides a description of the work request (i.e., register, modify, etc.), a created on column 126 that displays the time and date when the work request was created, and a price column 128 that provides the cost of the service.

Embodiments of the present invention allow the profiles to be securely modified by an authorized administrative user. After the profiles are modified, the system will automatically update all domain name registrations to reflect the modification. For example, if the contact profile is modified so that the main contact changes, then the system will automatically notify the relevant TLD Registry databases that the contact information has been changed for all of the previously created domain names where possible (i.e., some countries have limited electronic interfaces). In all cases, the domain name record will be updated and the modification be reflected in the system.

As disclosed, embodiments of the present invention allows for the acquisition and management of digital vital records by providing a series of profiles that include all critical information for each digital record. A user selects the desired profiles rather than entering information. Because the profiles reflect previously defined company policies and procedures, the acquisition, management, and enforcement of digital vital records automatically adhere to the procedures and policies, ensuring that internal and external compliance needs are met.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of managing digital records for an organization, the method comprising:
receiving a request for an action on a digital record, said digital record comprising critical elements;
presenting one or more profiles for at least one of the critical elements, wherein the profiles incorporate digital record management procedures of the organization;
receiving a selection of one of the one or more profiles; and
executing the action based on the selection.

2. The method of claim 1, wherein the digital record is a domain name record.

3. The method of claim 2, wherein the action comprises registering a domain name record.

4. The method of claim 2, wherein the action comprises modifying a domain name record.

5. The method of claim 2, wherein the critical elements comprise contact information.

6. The method of claim 2, wherein the critical elements comprise domain name server information.

7. The method of claim 1, wherein a selection of a critical element for which one or more profiles will be presented is based on the requested action.

8. The method of claim 1, further comprising:
permitting modification of the profiles only by authorized users.

9. The method of claim 2, further comprising:
interfacing with a domain name registrar to execute the action.

10. A digital record system for managing digital records that comprise critical elements, said system comprising:
a computer processor; and
a memory device coupled to said processor, said memory device having instructions stored thereon that, when executed by said processor, cause the system to:
based on a received request for an action on a digital record, display a menu of one or more profiles for at least one of the critical elements, wherein the profiles incorporate digital record management procedures; and
based on a received selection of one of the one or more profiles, execute the action.

11. The system of claim 10, wherein the digital record is a domain name record.

12. The system of claim 11, wherein the action comprises registering a domain name record.

13. The system of claim 11, wherein the action comprises modifying a domain name record.

14. The system of claim 11, wherein the critical elements comprise contact information.

15. The system of claim 11, wherein the critical elements comprise domain name server information.

16. The system of claim 10, wherein a selection of a critical element for which one or more profiles will be presented is based on the requested action.

17. The system of claim 10, further causing said system to permit modification of the profiles only by authorized users.

18. The system of claim 11, further causing said system to interface with a domain name registrar to execute the action.

19. A computer readable medium having instructions stored thereon that, when executed by a processor, cause the processor to:
in response to a received request for an action on a digital record comprised of a plurality of critical elements, display a menu of one or more profiles for at least one of the critical elements, wherein the profiles incorporate digital record management procedures; and
in response to a received selection of one of the one or more profiles, execute the action.

20. The computer readable medium of claim 19, wherein the digital record is a domain name record.

21. A system for managing digital records for an organization, the method comprising:
means for receiving a request for an action on a digital record, said digital record comprising critical elements;
means for presenting one or more profiles for at least one of the critical elements, wherein the profiles incorporate digital record management procedures of the organization;
means for receiving a selection of one of the one or more profiles; and
means for executing the action based on the selection.
